(19) United States
(12) Patent Application Publication
(10) Pub. No.: US 2026/0359232 A1
(43) Pub. Date: Nov. 12, 2026

(54) CONFIGURABLE HOST MEMORY BUFFER ARCHITECTURE FOR MEMORY SYSTEMS

(71) Applicant: Micron Technology, Inc., Boise, ID (US)

(72) Inventors: John E. Maroney, Irvine, CA (US); Pedro Cordon, Irvine, CA (US); Pierre Labat, Campbell, CA (US); Henry H. Torabi, Irvine, CA (US)

(21) Appl. No.: 19/204,242

(22) Filed: May 9, 2025

(51) Int. Cl. G06F 12/14; G06F 12/02; G06F 13/16

(52) U.S. Cl. CPC G06F 12/1408; G06F 12/0246; G06F 12/145; G06F 13/1673; G06F 2212/7201

(57) ABSTRACT

Methods, systems, and devices for configurable host memory buffer architecture for memory systems are described. In response to a write command from a host system, the memory system may write data corresponding to the write command to a cache of the memory system. The memory system may also generate and store logical-to-physical (L2P) mapping information for the data that maps logical block addresses of the data to physical addresses in a non-volatile memory of the memory system. In response to committing the data to non-volatile memory, the memory system may transfer the L2P mapping information from the cache to a buffer of the host system. The buffer may be partitioned into different ranges of addresses each associated with a respective function. The memory system may retrieve the L2P mapping information for the data in response to a read command.

### TECHNICAL FIELD

The following relates to one or more systems for memory, including configurable host memory buffer architecture for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports configurable host memory buffer (HMB) architecture for memory systems in accordance with examples as disclosed herein.

FIG. 2 shows an example of an architecture that supports configurable HMB architecture for memory systems in accordance with examples as disclosed herein.

FIG. 3 shows an example of a system that supports configurable HMB architecture for memory systems in accordance with examples as disclosed herein.

FIG. 4 shows a block diagram of a memory system that supports configurable HMB architecture for memory systems in accordance with examples as disclosed herein.

FIG. 5 shows a flowchart illustrating a method or methods that support configurable HMB architecture for memory systems in accordance with examples as disclosed herein.

### DETAILED DESCRIPTION

Some memory systems (e.g., single root input-output virtualization (SRIOV) systems) may use volatile memory (e.g., dynamic random access memory (DRAM)) to maintain logical-to-physical (L2P) mapping information, which may reduce a write amplification factor (WAF) associated with the memory system and increase a steady state performance (e.g., random read and random write performance). For example, by maintaining L2P information in volatile memory, the memory system may reduce accesses to non-volatile memory, which may increase performance and efficiency, among other examples. Some other memory systems may implement single function storage without using volatile memory to reduce a cost of manufacturing and operating the memory system. Such memory systems may store L2P information in non-volatile memory, which may increase a WAF associated with the memory system and may reduce a steady state performance of the memory system, among other examples. Additionally, or alternatively, some memory systems may store relatively small amounts of L2P information in a relatively small buffer at a host system. However, techniques for expanding storage for relatively quick-access L2P mapping information for memory systems without excess volatile memory capacity may be beneficial.

As described herein, a multi-function memory system may use storage space within a volatile memory (e.g., a host memory buffer (HMB)) of a host system for longer-term storage of L2P mapping information to increase a steady state performance of the memory system (e.g., without using volatile memory in the memory system or flushing such L2P mapping information to non-volatile memory of the memory system). A multi-function memory system may store data across one or more different sets of address ranges, which may be referred to as namespaces herein. A multi-function memory system may be a system that supports execution of multiple applications executed by multiple host systems, a system with multiple ports, a system with multiple namespaces, or the like. The memory system may support using an HMB accordingly for multi-port, multi-function, and multi-namespace implementations with both volatile and non-volatile write caches for multiple power backup architectures.

In response to a write command from a host system, the memory system may temporarily write data corresponding to the write command to a cache of the memory system. The memory system may generate and store L2P mapping information for the data that maps LBAs of the data to physical addresses in a non-volatile memory of the memory system. In response to committing (e.g., flushing, transferring) the data to non-volatile memory, the memory system may transfer the L2P mapping information from the cache to a volatile memory (e.g., an HMB) of the host system. The volatile memory may be partitioned into different ranges of addresses each associated with a respective function (e.g., a respective namespace in the memory system, a respective port, or the like). If the memory system receives a read command from the host system that requests a read of the data, the memory system may retrieve the L2P mapping information for the data from the volatile memory (e.g., the HMB). Accordingly, the memory system may read the first data from non-volatile memory based on the L2P mapping information (e.g., stored at the HMB) and the read command.

In addition to applicability in memory systems as described herein, techniques for configurable HMB architecture for memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by using a host volatile memory for L2P mapping information, which may increase a DRAM-less steady state performance of a memory system and may improve hardware speeds for L2P table updates and lookups, thereby reducing latency. These techniques may also accommodate multi-function and multi-namespace functionality with caches for various power backup architectures, among other benefits.

In addition to applicability in memory systems as described herein, techniques for configurable HMB architecture for memory systems may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing use of DRAM space for L2P mapping information, which may reduce materials and cost used for adding DRAM to a memory system, and thus may reduce electronic waste, among other benefits.

Features of the disclosure are illustrated and described in the context of systems, devices, and circuits. Features of the disclosure are further illustrated and described in the context of an architecture and flowcharts.

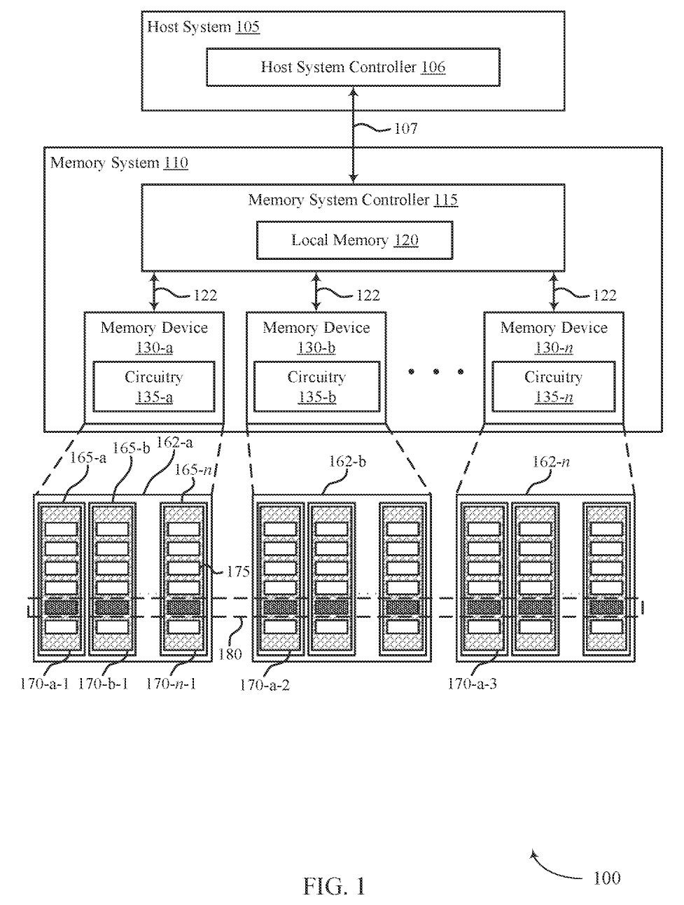

FIG. 1 shows an example of a system 100 that supports configurable HMB architecture for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-n, where n represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DRR interfaces, ONFI interfaces, and the like. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., static random access memory (SRAM), DRAM, or other memory) that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or respective circuitry 135, which may be internal to memory devices 130, respectively, to perform the functions ascribed herein to the memory system controller 115. In general, one or more functions ascribed herein to the memory system controller 115 may, in some cases, be performed instead by the host system 105, circuitry 135, or any combination thereof. For example, the circuitry 135 may be or include a microcontroller, special purpose logic circuitry (e.g., an FPGA, an ASIC, a DSP), or any other suitable processor or processing circuitry. Thus, in some instances, “processor” or “processing circuitry” may refer to functions performed by the memory system controller 115, the host system 105, the circuitry 135 of one or more memory devices 130, or any combination thereof. In some cases, a memory system 110 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-n may include circuitry 135-n.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include n planes 165 and each plane may include m blocks 170, where n and m represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, concurrent operations may be performed on different planes 165 or on different blocks 170. For example, concurrent operations may be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-n, where n represents an Nth plane. The memory die 162-b and the memory die 162-n may also include N planes. In some cases, an individual block 170 may be referred to as a physical block, and a virtual block 180 may refer to a group of physical blocks 170 within which concurrent operations may occur. A virtual block 180 may be a logical structure that includes a plurality of blocks, where different blocks of the plurality of blocks may come from different planes 165 or different memory dies 162. In some cases, a virtual block may include blocks 170 from different memory devices 130 (e.g., including blocks in one or more planes 165 of memory device 130-a, memory device 130-b, and memory device 130-n). In some examples, a virtual block may include a respective block from each plane 165 (e.g., a block 170 from each plane 165) of one or more memory dies 162.

In some cases, the blocks 170 within a virtual block may have the same block address within their respective planes 165. For example, block 170-a-1 may be “block 0” of a first plane of die 162-a, block 170-a-2 may be “block 0” of a first plane of die 162-b, block 170-a-3 may be “block 0” of a first plane of die 162-n, and so on. By way of further example, block 170-b-1 may be “block 1” of a first plane of die 162-a and block 170-n-1 may be “block n” of die 162-a, where n represents an Nth block. The memory die 162-b and the memory die 162-n may also include N blocks. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

In some cases, to update some data within a block 170 while retaining other data within the block 170, the memory device 130 may write the updated data to a new block 170. The memory device 130 (e.g., circuitry 135) or the memory system controller 115 may mark or otherwise designate the addresses of the data that was updated in the block 170 as invalid or obsolete and may update an L2P mapping table to associate the logical address (e.g., LBA) for the data with the new block 170 rather than the original block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by circuitry 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

Some manufacturers of memory systems (e.g., automotive customers) that implement centralized SRIOV storage may use DRAM in the memory system (e.g., SSDs). For example, a memory system may include DRAM to reduce a WAF and to achieve a target steady state performance (e.g., enterprise random read and random write steady state performance). In some cases, this may reduce L2P updates to NAND memory of the memory system. Some manufacturers that implement single function storage may use memory systems (e.g., SSDs) without DRAM. Excluding DRAM from a memory system or otherwise including a relatively smaller amount of DRAM or other volatile memory in a memory system may reduce a cost of the memory system but may increase a WAF and may diminish a steady state performance of the memory system. In some cases, a memory system that does not use DRAM (e.g., DRAM-less SSDs) may use a relatively small amount of volatile memory (e.g., HMB) in a host system memory for L2P updates (e.g., for a limited range of addresses). For example, a memory system may use a relatively small amount of volatile memory (e.g., HMB) to increase a limited range (e.g., using 64MB of HMB for 64GB of range). This amount of volatile memory (e.g., HMB) may be inadequate to achieve a target steady state performance for multi-function and multi-namespace applications (e.g., used for centralized storage applications). Some operating systems may implement volatile memory spaces (e.g., HMBs) that are relatively limited in size (e.g., 128MB with a 4KB memory page size).

As described herein, the memory system 110 (e.g., a multi-function memory system) may store data across one or more different sets of address ranges (e.g., namespaces). The memory system 110 may be a system that supports execution of multiple applications executed by multiple host systems, a system with multiple ports, a system with multiple namespaces, and the like. The memory system 110 may use storage space within a volatile memory (e.g., an HMB) of a host system for longer-term storage of L2P mapping information to increase a steady state performance of the memory system (e.g., while excluding or otherwise reducing an amount of DRAM and refraining from flushing such L2P mapping information to NAND). The memory system 110 may support using host volatile memory (e.g., an HMB) accordingly for multi-port, multi-function, and multi-namespace functionalities and may implement both volatile and non-volatile write caches for multiple power backup architectures.

If the memory system 110 receives a write command from a host system 105, the memory system 110 may write data corresponding to the write command to a cache of the memory system (e.g., temporarily, for a duration). The memory system 110 may also generate L2P mapping information for the data that maps LBAs of the data to physical addresses in a non-volatile memory of the memory system 110. Then, the memory system 110 may store the L2P mapping information (e.g., at a cache of the memory system 110). In response to moving (e.g., committing, flushing, transferring) the data to non-volatile memory, the memory system 110 may transfer the L2P mapping information from the cache to a volatile memory (e.g., an HMB) of the host system 105. The volatile memory may be partitioned into different ranges of addresses each associated with a respective function (e.g., a respective namespace in the memory system, a respective port, a respective function, etc.).

In response to receiving a read command from the host system 105 (e.g., requesting the data), the memory system 110 may retrieve the L2P mapping information for the data. For example, the memory system 110 may receive the L2P mapping information from the host system 105 (e.g., in response to a request for the L2P mapping information, or in accordance with receiving the read command). Accordingly, the memory system 110 may read the first data from non-volatile memory based on the L2P mapping information (e.g., stored at the HMB) and the read command.

As described herein, a “cache” may refer to a hardware or software component that stores information at a memory system 110 (or a host system 105). The memory system 110 may access a cache faster than other areas of memory (e.g., without using one or more look up tables). Accordingly, the memory system 110 may store, in the cache, information that is expected to be accessed frequently. A cache, as described herein, may be a volatile cache such as a volatile write cache (e.g., a cache stored in volatile memory) or a non-volatile cache such as a non-volatile write cache (e.g., a cache stored in non-volatile memory). The term “namespace” may refer to a logical grouping of identifiers used in a memory system. A namespace may include identifiers that are all associated with a single function, operation, controller, or the like. The term “region” may refer to a defined quantity of space within memory, such as one or more memory cells, one or more blocks of memory, a quantity of available storage space (e.g., megabytes, gigabytes, and so on), or the like.

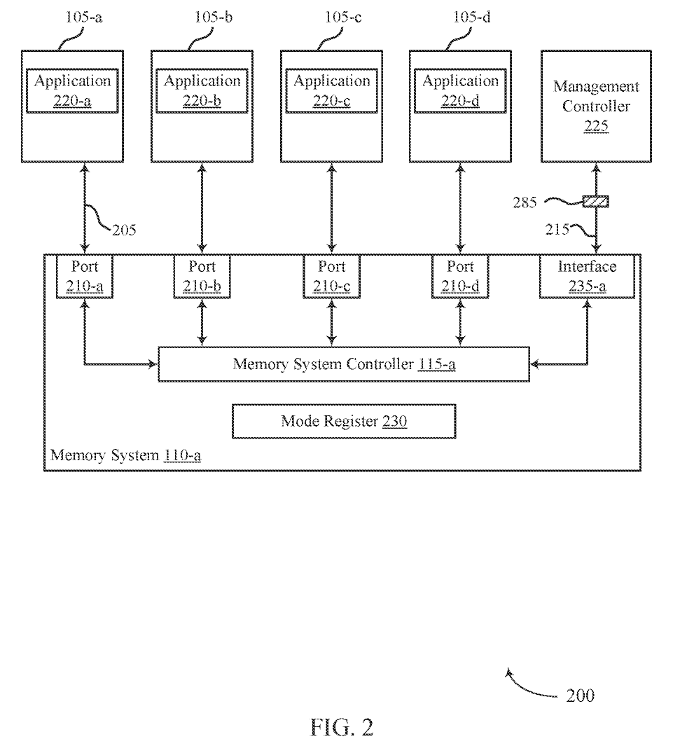

FIG. 2 shows an example of an architecture 200 that supports configurable HMB architecture for memory systems in accordance with examples as disclosed herein. One or more aspects of the architecture 200 may implement or may be implemented by one or more aspects of the system 100. For example, the architecture 200 may include a host system 105-a, a host system 105-b, a host system 105-c, a host system 105-d, and a memory system 110-a with a memory system controller 115-a and a mode register 230, which may be examples of corresponding devices or systems described herein. In some cases, the architecture 200 may be implemented in or as part of an automotive system, and the architecture 200 may support increased performance, reliability, and sustainability for memory systems included within the automative system as described herein.

For example, memory system 110-a may be a multi-ported memory system and may include a port 210-a, a port 210-b, a port 210-c, and a port 210-d. The ports 210 may allow for multiple host systems 105 to establish connections with the memory system 110-a and to execute commands using the memory system 110-a for executing applications 220 (e.g., or functions). For example, a host system 105-a may be coupled with the memory system 110-a via the port 210-a and may host (e.g., and may execute commands for) an application 220-a. A host system 105-b may be coupled with the memory system 110-a via the port 210-b and may host an application 220-b, a host system 105-c may be coupled with the memory system via the memory system 110-a via the port 210-c and may host an application 220-c, and a host system 105-d may be coupled with the memory system 110-a via the port 210-d and may host an application 220-d. In some examples, each port 210 may operate independently. For example, each port 210 may involve different link speeds (e.g., PCIe link speeds) or may be reset independently. Further, the ports 210 may operate simultaneously or concurrently, or at different times. In some cases, boot partitions, replay protected memory blocks (RPMBs), virtualization (e.g., single root I/O virtualization (SRIOV)), and resource allocation may also be per port.

Although the architecture 200 illustrates four host systems 105 and four ports 210, it is to be understood that a memory system may include any quantity and combination of ports and host systems, including four of each, or any other quantities. The memory system 110-a may include one or more memory arrays across one or more memory devices that store data for the execution of the various applications. The ports may provide an interface for communicating commands and data with the host systems 105, but the actual data for each host system 105 may be stored in various locations within the memory system 110-a.

In some examples, the host systems 105 may transmit commands (e.g., in-band commands) that are associated with execution of an application 220. The host systems 105 may be controlled by or may include one or more components or systems of an automotive platform, and applications 220 may support one or more functions of the automotive platform or some other type of platform. Such commands may be communicated to the memory system 110-a via a peripheral component interconnect (PCI) interface 205 between a host system 105 and a port 210 of the memory system 110-a, which may be referred to as an in-band channel. The host systems 105 may communicate with the memory system 110-a using the ports 210 via in-band signaling (e.g., via a PCIe bus) which may differ from out-of-band (OOB) signaling, as the interface 205 may support transfer of data and commands, while one or more OOB channels may not be used for data transfer, but may instead be used for transfer of metadata and other management commands. Commands sent by a host system 105 may cause or instruct the memory system controller 115-a to execute operations or access memory (e.g., at one or more memory devices 130 of the memory system 110-a). The commands may be non-volatile memory express (NVMe) commands, or some other type of command.

In some examples, the memory system 110-a may include an interface 235-a (e.g., a management port, a management end point) which may be used for managing one or more aspects of the memory system 110-a. For example, the memory system 110-a may receive, via the interface 235-a, one or more configurations 285 to support an HMB architecture for storing L2P mapping information (e.g., to reduce or exclude DRAM at the memory system 110-a). The interface 235-a may be coupled with a management controller 225, which may be an example of a host system or other trusted management system within a device (e.g., an automotive device), via a link 215, which may be a system management bus (SMBus), or some other type of link 215. The one or more configurations 285 may include an indication of a volatile memory structure (e.g., an HMB structure) of one or more host systems 105, a parity configuration (e.g., a cyclic redundancy check (CRC) configuration) for L2P mapping information, an encryption configuration for L2P mapping information, or any combination thereof. In some cases, a host system 105 may include an input-output memory management unit (IOMMU) to control input and output of L2P mapping information associated with the memory system 110-a.

The architecture 200 may support a multi-function memory system (e.g., the memory system 110-a) that stores data at multiple (e.g., different) sets of address ranges, which may be referred to as namespaces. A multi-function memory system may be a system that supports execution of multiple applications 220. Such applications 220 may be executed by multiple host systems 105, by (e.g., using, via) multiple ports 210, using data stored across multiple namespaces, or the like. That is, each application 220 may execute according to a respective host system 105, a respective namespace, a respective port 210, or any combination thereof, and each of the application, the namespace, the port 210, the host system 105, or any combination thereof may be referred to as a function in some examples herein. As described herein, the memory system 110-a may use storage space within a volatile memory (e.g., an HMB) of a host system 105 for longer-term storage of L2P mapping information, which may increase a steady state performance of the memory system 110-a (e.g., without using DRAM or flushing the L2P mapping information to NAND). The memory system 110-a may support using volatile memory of a host system (e.g., an HMB) accordingly for multi-port, multi-function, and multi-namespace implementations, with both volatile and non-volatile write caches, for multiple power backup architectures.

In response to a write command from a host system 105, the memory system 110-a may write data corresponding to the write command to a cache (e.g., SRAM) of the memory system 110-a. The memory system 110-a may also generate and store L2P mapping information for the data. The L2P mapping information may map LBAs of the data to physical addresses in a non-volatile memory of the memory system 110-a. In response to committing (e.g., flushing, transferring) the data to non-volatile memory, the memory system 110-a may transfer the L2P mapping information from the cache to a volatile memory (e.g., an HMB) of the host system 105. The volatile memory may be partitioned into different ranges of addresses each associated with a respective function (e.g., a respective namespace in the memory system 110-a, a respective port, a respective function, etc.). If the memory system 110-a receives an access (e.g., read) command from the host system 105 (e.g., a read command that requests the data), the memory system 110-a may retrieve the L2P mapping information for the data (e.g., from the host system 105). Accordingly, the memory system 110-a may read the first data from non-volatile memory based on the L2P mapping information (e.g., stored at the HMB) and the read command. As described herein, a function may refer to an operation, a port, an application, a controller, or any combination thereof. For example, a memory system 110 may support multiple functions.

In some implementations, the memory system 110-a may transfer L2P mapping table information from a virtual L2P cache to extend up to an entire size of a table in an HMB (e.g., a same size as may be persisted in non-volatile memory after a flush). This transfer from virtual SRAM L2P buffer to host memory space may be facilitated by L2P updates or L2P lookups and trim engines (e.g., TRIMs). Further, the transfer may be facilitated based on direct memory accesses and caching extension hardware acceleration partitioned according to a granularity that is based on a function (e.g., a granularity of a namespace or function). Each function may call one or more HMB descriptors to extend an HMB size (e.g., range) to a gigabyte range that is based on an addressing range used for one or multiple namespaces.

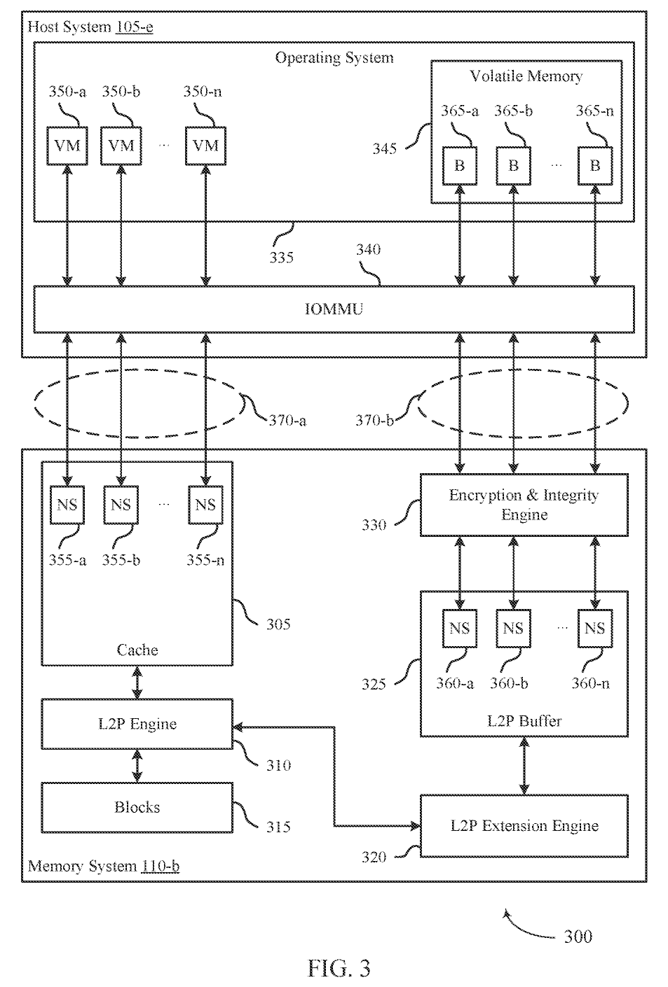

In some examples, the memory system 110-a may store data for applications associated with relatively high reliability and performance requirements, such as a vehicle or other automated system. In such cases, the configurable HMB architecture described herein may reduce a likelihood of system failure and electronic waste. Techniques for such an HMB architecture within a multi-ported memory system are described in further detail elsewhere herein, including with reference to FIG. 3.

FIG. 3 shows an example of a system 300 that supports configurable HMB architecture for memory systems in accordance with examples as disclosed herein. In some cases, the system 300 may implement or be implemented by aspects of the system 100 and the architecture 200. For example, the system 300 may include one or more memory systems 110 (e.g., a memory system 110-b) and one or more host systems 105 (e.g., a host system 105-e), which may be examples of the corresponding devices as described with respect to FIGS. 1 and 2. In the following description of the system 300, the operations between the memory system 110-b and the host system 105-e may be performed in a different order than the example order shown. Some operations may also be omitted from the described operations, and other operations may be added to the described operations. Further, although some operations or signaling may be described to occur at different times for discussion purposes, these operations may actually occur at the same time.

The memory system 110-b may include one or more memory and controller components, such as a cache 305, an L2P engine 310, a set of blocks 315, an L2P extension engine 320, an L2P buffer 325, an encryption and integrity engine 330 (e.g., an HMB encryption and integrity generator and checking engine), or any combination thereof. The set of blocks 315 may include virtual blocks corresponding to physical blocks at the memory system 110-b (e.g., NAND die virtual blocks). The L2P buffer 325 may be a virtual L2P buffer where values within the L2P buffer 325 may be stored in a RAM of the memory system 110-b. The host system 105-e may include one or more memory and controller components such as an operating system 335 and an IOMMU 340. The operating system 335 may include a volatile memory 345, which may be or may include one or more buffers 365-a, 365-b, through 365-n (e.g., one or more HMBs or portions of an HMB). For example, the volatile memory 345 may refer to an HMB as described herein, and vice versa (e.g., references to an “HMB” or a “buffer” of a host system 105 may refer to the volatile memory 345). The host system 105-e may also include one or more virtual machines 350 (e.g., virtual machines 350-a, 350-b, through 350-n), which may correspond to spaces or regions of memory within the operating system 335 (e.g., the operating system 335 may allocate a portion of memory for each virtual machine 350). The host system 105-e may store, in the operating system 335 (e.g., corresponding to the one or more virtual machines 350), information passed to or from the memory system 110-b. Each buffer 365 may be associated with a respective range of addresses within the volatile memory 345 (e.g., a DRAM of the host system 105-e).

In some implementations, the memory system 110-b may communicate with the host system 105-e via one or more buses 370 (e.g., a bus 370-a and a bus 370-b), which may include one or more PCIe buses. In some examples, the bus 370-a and the bus 370-b may be combined as a single bus. The bus 370-a may include a set of traffic threads (e.g., input-output traffic threads). The bus 370-b may include a set of caching threads (e.g., HMB caching threads). In some cases, information transferred through the one or more buses 370 may pass via the IOMMU 340 to one or more memories of the host system 105-e.

As described herein, the term “element” (e.g., the one or more elements 355-a, 355-b, through 355-n) may refer to a space within memory, and may include one or more memory cells, blocks of memory, ranges of addresses within memory, or any combination thereof. For example, the memory system 110-b may dedicate one or more elements for storing information corresponding to each function of a set of functions supported by the memory system 110-b. In some cases, the host system 105-e may partition at least a portion of the volatile memory 345 according to a set of functions supported or used by the memory system 110-b. That is, each buffer 365 (e.g., HMB) of the volatile memory 345 may correspond to a respective function (e.g., namespace) of the memory system 110-b. In some examples, the volatile memory 345 may be an HMB, including the one or more buffers 365 (e.g., sub-HMBs). In some cases, the memory system 110-b may partition at least a portion of the cache 305 and the L2P buffer 325 according to the set of functions supported or used by the memory system 110-b. For example, the cache 305 may include one or more elements 355 (e.g., namespace elements) and the L2P buffer 325 may include one or more elements 360 (e.g., elements 360-a, 360-b, through 360-n). Each element 355 and each element 360 may correspond to a respective function (e.g., namespace) of the memory system 110-b.

In some implementations, multiple virtual machines 350 may operate within the host system 105-e. Each virtual machine 350 of the host system 105-e may be or may include an operating system, a processor, or another component (e.g., circuitry, an engine, or the like) that is operable to interface with the memory system 110-b. For example, each virtual machine 350 may interface with the memory system 110-b to execute one or more applications. In some cases, each virtual machine 350 may correspond to a respective set of one or more functions (e.g., supported by the memory system 110-b). Similarly, each portion of the memory allocated for a respective virtual machine 350 may also correspond to the respective set of one or more functions. In some examples, as described herein, each virtual machine 350 may correspond to or may represent a host system 105 (e.g., a virtual host system or a physical host system). For example, operations described to be performed by a virtual machine 350 may also be performed by a host system 105 (e.g., separate from the host system 105-e).

In some cases, the memory system 110-b may receive configuration information that indicates that a respective region (e.g., buffer 365) of the volatile memory 345 is allocated for each function of a set of functions. The memory system 110-b may support execution of the set of functions. The memory system 110-b may partition portions of the cache 305 and the L2P buffer 325 as described herein in accordance with the configuration information. The memory system 110-b may transfer L2P mapping information to the host system 105-e as described herein in accordance with the configuration.

In some implementations, the host system 105-e may include first data (e.g., stored at a portion of the memory corresponding to a first virtual machine 350-a) corresponding to a first function (e.g., a first namespace) of the set of functions. For example, the host system 105-e may receive the first data from a user or may otherwise generate the first data based on user input or based on execution of one or more applications. The memory system 110-b may receive, from the host system 105-e, an access command (e.g., a write command) that requests to write, to the memory system 110-b, the first data associated with the first function. The first function may be associated with a set of addresses in non-volatile memory of the memory system 110-b. In some cases, the memory system 110-b may generate (e.g., using the L2P engine 310) L2P mapping information based on the access command. The L2P mapping information may map one or more logical addresses (e.g., corresponding to the set of blocks 315) associated with the first data to one or more physical addresses of the set of addresses in the non-volatile memory of the memory system 110-b (e.g., the blocks 315).

In response to the access command, the memory system 110-b may write the first data and the L2P mapping information to the cache 305. For example, the memory system 110-b may write the first data to an element 355 of the cache 305 that corresponds to the first function (e.g., the element 355-a). In some cases, the memory system 110-b may transfer (e.g., commit, flush) the first data from the cache 305 to the non-volatile memory (e.g., in accordance with the access command and a commit or flush configuration of the memory system 110-b). In such cases, the memory system 110-b may transfer the L2P mapping information from the cache to the host system 105-e or to a component within the memory system 110-b based on transferring the first data from the cache to the non-volatile memory.

In some examples, the memory system 110-b may transfer the L2P mapping information from the cache 305 to the L2P buffer 325 (e.g., using the L2P engine 310 and the L2P extension engine 320). For example, the memory system 110-b may transfer the L2P mapping information corresponding to the first data to element 360-a (e.g., corresponding to the first function) using the L2P extension engine 320. In some cases, the memory system 110-b may transfer the L2P mapping information from the cache to a first region (e.g., buffer 365) of the volatile memory 345 at the host system 105-e based on the first function being associated with the first region. The L2P extension engine 320 may be an HMB L2P extension engine (e.g., a direct memory access engine, a caching engine, or a trim engine) at the memory system 110-b. The L2P extension engine 320 may facilitate organizing information within the L2P buffer 325 for transferring to and from the volatile memory 345. The L2P buffer 325 may include a set of memory cells associated with a set of virtual addresses within the memory system 110-b.

In some implementations, the memory system 110-b may perform an encryption and integrity procedure (e.g., using the encryption and integrity engine 330) on the L2P mapping information based on transferring the first data from the cache 305 to the non-volatile memory. Accordingly, the memory system 110-b may transfer the L2P mapping information from the cache 305 to the volatile memory 345 at the host system 105-e based on (e.g., after) the encryption and integrity procedure. In some cases, the encryption and integrity procedure may include an encryption operation (e.g., an advanced encryption standard (AES) operation) and an integrity operation (e.g., a CRC operation). To perform the encryption operation, the memory system 110-b may generate a set of encryption bits corresponding to the L2P mapping information (e.g., to encrypt the L2P mapping information for transferring to the host system 105-e). The encryption and integrity engine 330 may recover the L2P mapping information using the set of encryption bits. To perform the integrity operation, the memory system 110-b may generate a set of parity bits corresponding to the L2P mapping information. Accordingly, the memory system 110-b may transfer the set of encryption bits and the set of integrity bits with the L2P mapping information from the cache 305 to the host system 105-e.

In some implementations, the memory system 110-b may transfer second L2P mapping information associated with second data to a second region (e.g., buffer 365-b) of the volatile memory 345. For example, the memory system 110-b may transfer the second L2P mapping information to the second region if a second function that corresponds to the second data is associated with the second region. The second L2P mapping information may map one or more second logical addresses associated with the second data to one or more second physical addresses in the non-volatile memory of the memory system 110-b.

The host system 105-e may receive the L2P mapping information (along with the encryption and integrity bits) via the IOMMU 340. Accordingly, the host system 105-e may store the L2P mapping information at a buffer 365 of the volatile memory 345 that corresponds to the first function of the memory system 110-b (e.g., buffer 365-a). Similarly, the host system 105-e may receive the second L2P mapping information and may store the second L2P mapping information at a buffer 365 that corresponds to the second function of the memory system 110-b (e.g., buffer 365-b). The host system 105-e may similarly receive and store other L2P mapping information corresponding to other functions at other buffers 365 of the volatile memory 345.

In some implementations, the host system 105-e may retain L2P mapping information at the volatile memory 345 (e.g., regardless of a reset operation of a function corresponding to the L2P mapping information). For example, the memory system 110-b may perform a reset operation associated with at least the first function after transferring the L2P mapping information from the cache 305 to the host system 105-e. After the reset operation, the memory system 110-b may receive the L2P mapping information from the host system 105-e (e.g., for performing a read operation at the memory system 110-b). That is, by storing the L2P mapping information at the host system 105-e, the L2P mapping information may be maintained even if the memory system 110-b is reset or otherwise loses power for some time.

In some implementations, the memory system 110-b may receive a second access command (e.g., from the host system 105-e) that requests to read the first data from the memory system 110-b. The second access command may indicate the one or more logical addresses associated with the first data. The memory system 110-b may receive, from the host system 105-e, the L2P mapping information that maps the one or more logical addresses associated with the first data to the one or more physical addresses of the set of addresses in the non-volatile memory. In some examples, the memory system 110-b may receive the L2P mapping information in the second access command or in one or more other messages from the host system 105-e.

In some cases, the memory system 110-b may receive the encryption and integrity bits with the L2P mapping information. In such cases, the memory system 110-b may perform a decryption and integrity check procedure on the L2P mapping information in response to receiving the L2P mapping information from the host system. In any case, the memory system 110-b may read the first data from the set of addresses in the non-volatile memory based on the L2P mapping information and in response to the second access command (and based on the decryption and integrity check procedure).

The configurable HMB architecture described herein may be referred to as enhanced HMB (e.g., ultra HMB, fully configurable and virtualized HMB architecture), which may be applied in automotive memory systems or other types of memory systems. Enhanced HMB may allow for a reduced cost for memory systems with a relatively low cost to a host system for volatile memory (e.g., DRAM), thereby reducing a total assembly and test cost of memory systems and host systems (e.g., within automotive systems). Enhanced HMB may extend a first, relatively low, steady state performance for a memory system that does not include volatile memory or includes relatively small amounts of volatile memory (e.g., DRAM-less) to a second, relatively higher, steady state performance associated with memory systems that do include DRAM (e.g., by using an increased amount of host memory for an L2P DRAM buffer). For example, the host system 105-e may use one or more gigabytes of volatile memory 345 (e.g., rather than a range of 64 megabytes to 128 megabytes for fresh out of box performance). The host system 105-b may accommodate the additional range of HMB by using a set of buffer chunks (e.g., buffers 365) per element 355, namespace, function, or descriptor (e.g., at least 4MB HMB chunks per descriptor and up to 1024 HMB namespaces, functions, or descriptors).

Enhanced HMB may accommodate multi-port, multi-function, and multi-namespace functionality with volatile write caches and non-volatile write caches for different power backup architectures. As described herein, enhanced HMB may split (e.g., partition) hardware and software by function or namespace (e.g., for improved L2P and trim isolation). In some cases, each function of the memory system 110-b may call one or more HMB descriptors (e.g., based on a range used for one or one or more namespaces, corresponding to the elements 355). Enhanced HMB may improve a hardware acceleration for L2P table updates and lookups (e.g., using the L2P extension engine 320) and L2P trims in a virtual L2P buffer (e.g., the L2P buffer 325), which may map to the volatile memory 345 of the host system 105-e. Accordingly, enhanced HMB may reduce latency for volatile memory updates and deallocation in a memory space of the host system 105-e. In some cases, the memory system 110-b may support a full steady state performance on a particular function or namespace (e.g., corresponding to an element 355) that is fully backed by the volatile memory 345 of the host system 105-e (e.g., an HMB). For example, the host system 105-e may allocate full performance on a particular function or namespace (e.g., corresponding to an element 355) that is fully backed by the volatile memory 345 of the host system 105-b (e.g., for relatively high demand applications). Additionally, or alternatively, the host system 105-e may allocate relatively little volatile memory space for relatively non-demanding applications.

An operating system 335 associated with the host system 105-e (and with the memory system 110-b) may support a volatile memory 345 (e.g., an HMB) of any size. The volatile memory 345 may be instantiated in the operating system 335 on a per controller basis (e.g., on a per NVMe controller basis). For example, the operating system 335 may instantiate the volatile memory 345 according to one or more controllers such as an SRIOV primary function (e.g., primary controller) or one or more SRIOV virtual functions (e.g., secondary controllers). Additionally, or alternatively, the operating system 335 may instantiate the volatile memory 345 according to one or more ports of a multiport memory system (e.g., one controller per port) or according to one or more functions of a multifunction memory system. As described herein, the operating system 335 may retain (e.g., persist) the volatile memory 345 across controller resets.

In some implementations, the operating system 335 (e.g., the host system 105-e) may provide (e.g., present) the memory system 110-b with an allocated volatile memory space (e.g., HMB space) via a quantity of NVMe HMB descriptors (e.g., a threshold quantity of contiguous fragments). Although a fragment may appear contiguous to the memory system 110-b, the fragment may be contiguous or non-contiguous within a memory of the host system 105-e (e.g., the volatile memory 345). Accordingly, the host system 105-e may use the IOMMU 340 and a page table that translates an address range of the fragment (e.g., received from the memory system 110-b) to one or more physical ranges of the volatile memory 345. In some examples (e.g., for a 2 GiB HMB), the memory system 110-b may support a threshold quantity of HMB descriptors (e.g., 512 HMB descriptors) and a threshold fragment size (e.g., at least 4 MiB). A granularity of HMB descriptors and fragment sizes may be based on a host configuration, on a fragmentation of a physical memory of the host system 105-e, or any combination thereof.

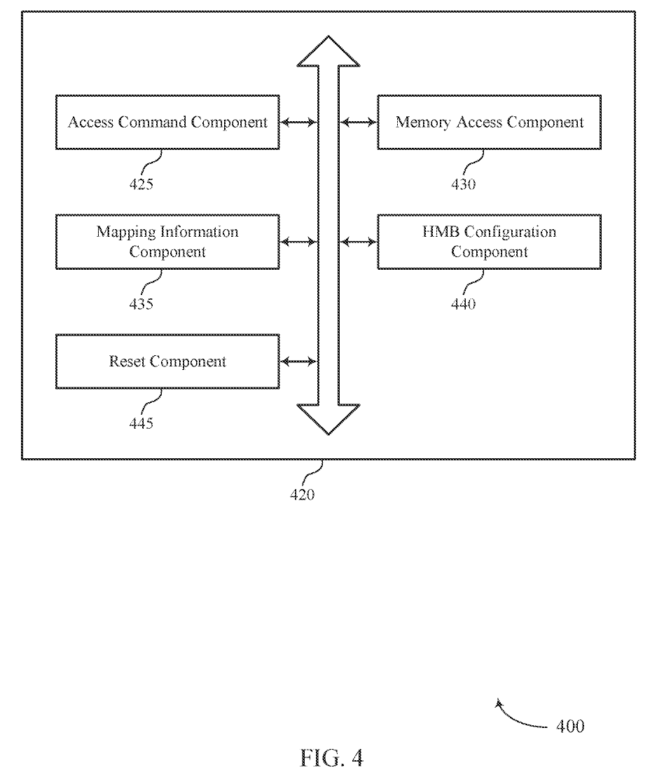

FIG. 4 shows a block diagram 400 of a memory system 420 that supports configurable HMB architecture for memory systems in accordance with examples as disclosed herein. The memory system 420 may be an example of aspects of a memory system as described with reference to FIGS. 1-3. The memory system 420, or various components thereof, may be an example of means for performing various aspects of configurable HMB architecture for memory systems as described herein. For example, the memory system 420 may include an access command component 425, a memory access component 430, a mapping information component 435, an HMB configuration component 440, a reset component 445, or any combination thereof. Each of these components, or components of subcomponents thereof (e.g., one or more processors, one or more memories), may communicate, directly or indirectly, with one another (e.g., via one or more buses).

The access command component 425 may be configured as or otherwise support a means for receiving an access command that requests to write first data associated with a first function to the memory system, where the first function is associated with a set of addresses in non-volatile memory of the memory system. The memory access component 430 may be configured as or otherwise support a means for writing, to a cache in the memory system and in response to the access command, the first data and L2P mapping information that maps one or more logical addresses associated with the first data to one or more physical addresses of the set of addresses in the non-volatile memory. The mapping information component 435 may be configured as or otherwise support a means for transferring the L2P mapping information from the cache based at least in part on transferring the first data from the cache to the non-volatile memory in response to the access command.

In some examples, the access command component 425 may be configured as or otherwise support a means for receiving a second access command that requests to read the first data from the memory system, the second access command indicating the one or more logical addresses associated with the first data. In some examples, the mapping information component 435 may be configured as or otherwise support a means for receiving, from a host system based at least in part on transferring the L2P mapping information from the cache to the host system, the L2P mapping information that maps the one or more logical addresses associated with the first data to the one or more physical addresses of the set of addresses in the non-volatile memory. In some examples, the memory access component 430 may be configured as or otherwise support a means for reading the first data from the set of addresses in the non-volatile memory based at least in part on the L2P mapping information and in response to the second access command.

In some examples, the mapping information component 435 may be configured as or otherwise support a means for performing a decryption and integrity check procedure on the L2P mapping information in response to receiving the L2P mapping information from the host system, where reading the first data is based at least in part on the decryption and integrity check procedure.

In some examples, the HMB configuration component 440 may be configured as or otherwise support a means for receiving configuration information that indicates a respective region of a plurality of regions of volatile memory in a buffer of a host system coupled with the memory system that is allocated for each function of a plurality of functions including at least the first function, where the L2P mapping information is transferred from the cache to a first region of the plurality of regions of the volatile memory in the buffer of the host system based at least in part on the first function being associated with the first region.

In some examples, the mapping information component 435 may be configured as or otherwise support a means for transferring second L2P mapping information associated with second data to a second region of the plurality of regions of the volatile memory in the buffer of the host system based at least in part on a second function that corresponds to the second data being associated with the second region, where the second L2P mapping information maps one or more second logical addresses associated with second data to one or more second physical addresses in the non-volatile memory of the memory system.

In some examples, the reset component 445 may be configured as or otherwise support a means for performing a reset operation associated with at least the first function after transferring the L2P mapping information from the cache to a host system coupled with the memory system. In some examples, the mapping information component 435 may be configured as or otherwise support a means for receiving, after the reset operation, the L2P mapping information from the host system.

In some examples, the mapping information component 435 may be configured as or otherwise support a means for generating the L2P mapping information based at least in part on the access command. In some examples, the mapping information component 435 may be configured as or otherwise support a means for storing the L2P mapping information in the cache or in a buffer at the memory system before transferring the L2P mapping information.

In some examples, the buffer includes a plurality of memory cells associated with a plurality of virtual addresses within the memory system.

In some examples, the mapping information component 435 may be configured as or otherwise support a means for performing an encryption and integrity procedure on the L2P mapping information based at least in part on transferring the first data from the cache to the non-volatile memory, where transferring the L2P mapping information from the cache is based at least in part on the encryption and integrity procedure.

In some examples, to support performing the encryption and integrity procedure, the mapping information component 435 may be configured as or otherwise support a means for generating a set of encryption and parity bits for the L2P mapping information. In some examples, to support performing the encryption and integrity procedure, the mapping information component 435 may be configured as or otherwise support a means for transferring the set of encryption and parity bits with the L2P mapping information from the cache.

In some examples, the memory system supports execution of a plurality of functions including at least the first function, the plurality of functions including one or more applications of the memory system, one or more controllers of the memory system, one or more ports of the memory system, or any combination thereof.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

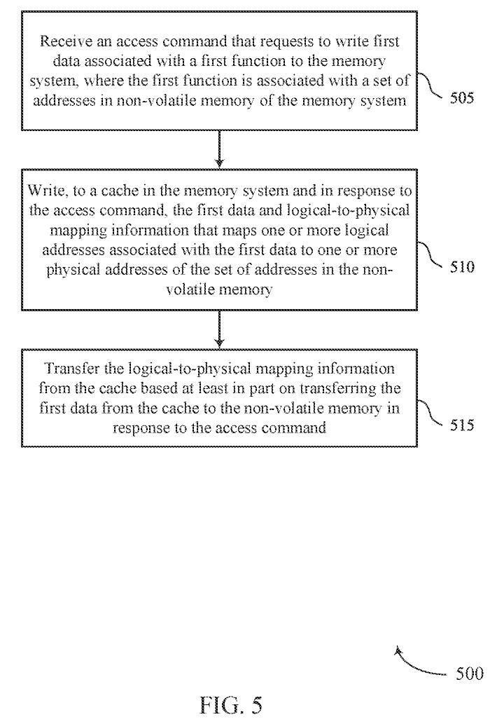

FIG. 5 shows a flowchart illustrating a method 500 that supports configurable HMB architecture for memory systems in accordance with examples as disclosed herein. The operations of method 500 may be implemented by a memory system or its components as described herein. For example, the operations of method 500 may be performed by a memory system as described with reference to FIGS. 1-4. In some examples, a memory system may execute a set of instructions to control the functional elements of the device to perform the described functions. Additionally, or alternatively, the memory system may perform aspects of the described functions using special-purpose hardware.

At 505, the method may include receiving an access command that requests to write first data associated with a first function to the memory system, where the first function is associated with a set of addresses in non-volatile memory of the memory system. In some examples, aspects of the operations of 505 may be performed by an access command component 425 as described with reference to FIG. 4.

At 510, the method may include writing, to a cache in the memory system and in response to the access command, the first data and L2P mapping information that maps one or more logical addresses associated with the first data to one or more physical addresses of the set of addresses in the non-volatile memory. In some examples, aspects of the operations of 510 may be performed by a memory access component 430 as described with reference to FIG. 4.

At 515, the method may include transferring the L2P mapping information from the cache based at least in part on transferring the first data from the cache to the non-volatile memory in response to the access command. In some examples, aspects of the operations of 515 may be performed by a mapping information component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving an access command that requests to write first data associated with a first function to the memory system, where the first function is associated with a set of addresses in non-volatile memory of the memory system; writing, to a cache in the memory system and in response to the access command, the first data and L2P mapping information that maps one or more logical addresses associated with the first data to one or more physical addresses of the set of addresses in the non-volatile memory; and transferring the L2P mapping information from the cache based at least in part on transferring the first data from the cache to the non-volatile memory in response to the access command.
Aspect 2: The method, apparatus, or non-transitory computer-readable medium of aspect 1, further including operations, features, circuitry, logic, means, or instructions, or any combination thereof for receiving a second access command that requests to read the first data from the memory system, the second access command indicating the one or more logical addresses associated with the first data; receiving, from a host system based at least in part on transferring the L2P mapping information from the cache to the host system, the L2P mapping information that maps the one or more logical addresses associated with the first data to the one or more physical addresses of the set of addresses in the non-volatile memory; and reading the first data from the set of addresses in the non-volatile memory based at least in part on the L2P mapping information and in response to the second access command.
Aspect 3: The method, apparatus, or non-transitory computer-readable medium of aspect 2, further including operations, features, circuitry, logic, means, or instructions, or any combination thereof for performing a decryption and integrity check procedure on the L2P mapping information in response to receiving the L2P mapping information from the host system, where reading the first data is based at least in part on the decryption and integrity check procedure.
Aspect 4: The method, apparatus, or non-transitory computer-readable medium of any of aspects 1 through 3, further including operations, features, circuitry, logic, means, or instructions, or any combination thereof for receiving configuration information that indicates a respective region of a plurality of regions of volatile memory in a buffer of a host system coupled with the memory system that is allocated for each function of a plurality of functions including at least the first function, where the L2P mapping information is transferred from the cache to a first region of the plurality of regions of the volatile memory in the buffer of the host system based at least in part on the first function being associated with the first region.
Aspect 5: The method, apparatus, or non-transitory computer-readable medium of aspect 4, further including operations, features, circuitry, logic, means, or instructions, or any combination thereof for transferring second L2P mapping information associated with second data to a second region of the plurality of regions of the volatile memory in the buffer of the host system based at least in part on a second function that corresponds to the second data being associated with the second region, where the second L2P mapping information maps one or more second logical addresses associated with second data to one or more second physical addresses in the non-volatile memory of the memory system.
Aspect 6: The method, apparatus, or non-transitory computer-readable medium of any of aspects 1 through 5, further including operations, features, circuitry, logic, means, or instructions, or any combination thereof for performing a reset operation associated with at least the first function after transferring the L2P mapping information from the cache to a host system coupled with the memory system and receiving, after the reset operation, the L2P mapping information from the host system.
Aspect 7: The method, apparatus, or non-transitory computer-readable medium of any of aspects 1 through 6, further including operations, features, circuitry, logic, means, or instructions, or any combination thereof for generating the L2P mapping information based at least in part on the access command and storing the L2P mapping information in the cache or in a buffer at the memory system before transferring the L2P mapping information.
Aspect 8: The method, apparatus, or non-transitory computer-readable medium of aspect 7, where the buffer includes a plurality of memory cells associated with a plurality of virtual addresses within the memory system.
Aspect 9: The method, apparatus, or non-transitory computer-readable medium of any of aspects 1 through 8, further including operations, features, circuitry, logic, means, or instructions, or any combination thereof for performing an encryption and integrity procedure on the L2P mapping information based at least in part on transferring the first data from the cache to the non-volatile memory, where transferring the L2P mapping information from the cache is based at least in part on the encryption and integrity procedure.
Aspect 10: The method, apparatus, or non-transitory computer-readable medium of aspect 9, where performing the encryption and integrity procedure includes operations, features, circuitry, logic, means, or instructions, or any combination thereof for generating a set of encryption and parity bits for the L2P mapping information and transferring the set of encryption and parity bits with the L2P mapping information from the cache.
Aspect 11: The method, apparatus, or non-transitory computer-readable medium of any of aspects 1 through 10, where the memory system supports execution of a plurality of functions including at least the first function, the plurality of functions including one or more applications of the memory system, one or more controllers of the memory system, one or more ports of the memory system, or any combination thereof.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive an access command that requests to write first data associated with a first function to the memory system, wherein the first function is associated with a set of addresses in non-volatile memory of the memory system;
write, to a cache in the memory system and in response to the access command, the first data and logical-to-physical mapping information that maps one or more logical addresses associated with the first data to one or more physical addresses of the set of addresses in the non-volatile memory; and
transfer the logical-to-physical mapping information from the cache based at least in part on transferring the first data from the cache to the non-volatile memory in response to the access command.

2. The memory system of claim 1, wherein the processing circuitry is further configured to cause the memory system to:
receive a second access command that requests to read the first data from the memory system, the second access command indicating the one or more logical addresses associated with the first data;
receive, from a host system based at least in part on transferring the logical-to-physical mapping information from the cache to the host system, the logical-to-physical mapping information that maps the one or more logical addresses associated with the first data to the one or more physical addresses of the set of addresses in the non-volatile memory; and
read the first data from the set of addresses in the non-volatile memory based at least in part on the logical-to-physical mapping information and in response to the second access command.

3. The memory system of claim 2, wherein the processing circuitry is further configured to cause the memory system to:
perform a decryption and integrity check procedure on the logical-to-physical mapping information in response to receiving the logical-to-physical mapping information from the host system, wherein reading the first data is based at least in part on the decryption and integrity check procedure.

4. The memory system of claim 1, wherein the processing circuitry is further configured to cause the memory system to:
receive configuration information that indicates a respective region of a plurality of regions of volatile memory in a buffer of a host system coupled with the memory system that is allocated for each function of a plurality of functions including at least the first function, wherein the logical-to-physical mapping information is transferred from the cache to a first region of the plurality of regions of the volatile memory in the buffer of the host system based at least in part on the first function being associated with the first region.

5. The memory system of claim 4, wherein the processing circuitry is further configured to cause the memory system to:
transfer second logical-to-physical mapping information associated with second data to a second region of the plurality of regions of the volatile memory in the buffer of the host system based at least in part on a second function that corresponds to the second data being associated with the second region, wherein the second logical-to-physical mapping information maps one or more second logical addresses associated with second data to one or more second physical addresses in the non-volatile memory of the memory system.

6. The memory system of claim 1, wherein the processing circuitry is further configured to cause the memory system to:
perform a reset operation associated with at least the first function after transferring the logical-to-physical mapping information from the cache to a host system coupled with the memory system; and
receive, after the reset operation, the logical-to-physical mapping information from the host system.

7. The memory system of claim 1, wherein the processing circuitry is further configured to cause the memory system to:
generate the logical-to-physical mapping information based at least in part on the access command; and
store the logical-to-physical mapping information in the cache or in a buffer at the memory system before transferring the logical-to-physical mapping information.

8. The memory system of claim 7, wherein the buffer comprises a plurality of memory cells associated with a plurality of virtual addresses within the memory system.

9. The memory system of claim 1, wherein the processing circuitry is further configured to cause the memory system to:
perform an encryption and integrity procedure on the logical-to-physical mapping information based at least in part on transferring the first data from the cache to the non-volatile memory, wherein transferring the logical-to-physical mapping information from the cache is based at least in part on the encryption and integrity procedure.

10. The memory system of claim 9, wherein, to perform the encryption and integrity procedure, the processing circuitry is further configured to cause the memory system to:
generate a set of encryption and parity bits for the logical-to-physical mapping information; and
transfer the set of encryption and parity bits with the logical-to-physical mapping information from the cache.

11. The memory system of claim 1, wherein the memory system supports execution of a plurality of functions comprising at least the first function, the plurality of functions comprising one or more applications of the memory system, one or more controllers of the memory system, one or more ports of the memory system, or any combination thereof.

12. A method by a memory system, comprising:
receiving an access command that requests to write first data associated with a first function to the memory system, wherein the first function is associated with a set of addresses in non-volatile memory of the memory system;
writing, to a cache in the memory system and in response to the access command, the first data and logical-to-physical mapping information that maps one or more logical addresses associated with the first data to one or more physical addresses of the set of addresses in the non-volatile memory; and
transferring the logical-to-physical mapping information from the cache based at least in part on transferring the first data from the cache to the non-volatile memory in response to the access command.

13. The method of claim 12, further comprising:
receiving a second access command that requests to read the first data from the memory system, the second access command indicating the one or more logical addresses associated with the first data;
receiving, from a host system based at least in part on transferring the logical-to-physical mapping information from the cache to the host system, the logical-to-physical mapping information that maps the one or more logical addresses associated with the first data to the one or more physical addresses of the set of addresses in the non-volatile memory; and
reading the first data from the set of addresses in the non-volatile memory based at least in part on the logical-to-physical mapping information and in response to the second access command.

14. The method of claim 12, further comprising:
receiving configuration information that indicates a respective region of a plurality of regions of volatile memory in a buffer of a host system coupled with the memory system that is allocated for each function of a plurality of functions including at least the first function, wherein the logical-to-physical mapping information is transferred from the cache to a first region of the plurality of regions of the volatile memory in the buffer of the host system based at least in part on the first function being associated with the first region.

15. The method of claim 12, further comprising:
performing a reset operation associated with at least the first function after transferring the logical-to-physical mapping information from the cache to a host system coupled with the memory system; and
receiving, after the reset operation, the logical-to-physical mapping information from the host system.

16. The method of claim 12, further comprising:
generating the logical-to-physical mapping information based at least in part on the access command; and
storing the logical-to-physical mapping information in the cache or in a buffer at the memory system before transferring the logical-to-physical mapping information.

17. The method of claim 12, further comprising:
performing an encryption and integrity procedure on the logical-to-physical mapping information based at least in part on transferring the first data from the cache to the non-volatile memory, wherein transferring the logical-to-physical mapping information from the cache is based at least in part on the encryption and integrity procedure.

18. A non-transitory computer-readable medium storing code comprising instructions which, when executed by one or more processors of a memory system, cause the memory system to:
receive an access command that requests to write first data associated with a first function to the memory system, wherein the first function is associated with a set of addresses in non-volatile memory of the memory system;
write, to a cache in the memory system and in response to the access command, the first data and logical-to-physical mapping information that maps one or more logical addresses associated with the first data to one or more physical addresses of the set of addresses in the non-volatile memory; and
transfer the logical-to-physical mapping information from the cache based at least in part on transferring the first data from the cache to the non-volatile memory in response to the access command.

19. The non-transitory computer-readable medium of claim 18, wherein the instructions, when executed by the one or more processors of the memory system, further cause the memory system to:
receive a second access command that requests to read the first data from the memory system, the second access command indicating the one or more logical addresses associated with the first data;
receive, from a host system based at least in part on transferring the logical-to-physical mapping information from the cache to the host system, the logical-to-physical mapping information that maps the one or more logical addresses associated with the first data to the one or more physical addresses of the set of addresses in the non-volatile memory; and
read the first data from the set of addresses in the non-volatile memory based at least in part on the logical-to-physical mapping information and in response to the second access command.

20. The non-transitory computer-readable medium of claim 18, wherein the instructions, when executed by the one or more processors of the memory system, further cause the memory system to:
receive configuration information that indicates a respective region of a plurality of regions of volatile memory in a buffer of a host system coupled with the memory system that is allocated for each function of a plurality of functions including at least the first function, wherein the logical-to-physical mapping information is transferred from the cache to a first region of the plurality of regions of the volatile memory in the buffer of the host system based at least in part on the first function being associated with the first region.

21. The non-transitory computer-readable medium of claim 18, wherein the instructions, when executed by the one or more processors of the memory system, further cause the memory system to:
perform a reset operation associated with at least the first function after transferring the logical-to-physical mapping information from the cache to a host system coupled with the memory system; and
receive, after the reset operation, the logical-to-physical mapping information from the host system.

22. The non-transitory computer-readable medium of claim 18, wherein the instructions, when executed by the one or more processors of the memory system, further cause the memory system to:
generate the logical-to-physical mapping information based at least in part on the access command; and
store the logical-to-physical mapping information in the cache or in a buffer at the memory system before transferring the logical-to-physical mapping information.
